(19) United States
(12) Patent Application Publication
(10) Pub. No.: US 2016/0291808 A1
(43) Pub. Date: Oct. 6, 2016

(54) DYNAMICALLY CREATED CONTEXTUAL INFORMATION VIA A BROWSER EXTENSION

(71) Applicant: salesforce.com, inc., San Francisco, CA (US)

(72) Inventors: Kedao Wang, Palo Alto, CA (US); Adam Evans, Redwood City, CA (US); Jason Li, Mountain View, CA (US); Gary Lerhaupt, San Francisco, CA (US); Catriona Cornett, San Francisco, CA (US)

(21) Appl. No.: 14/789,728

(22) Filed: Jul. 1, 2015

Related U.S. Application Data
(60) Provisional application No. 62/141,129, filed on Mar. 31, 2015.

(51) Int. Cl. G06F 3/0482

(52) U.S. Cl. CPC G06F 3/0482

(57) ABSTRACT

Methods and apparatuses for dynamic presentation of contextually relevant information. Access to an application is provided via a browser. Contextual information corresponding to individual entities is provided. The contextual information is retrieved from at least internal source and at least one external source. The contextual information is dynamically updated in response to input provide to the application to the browser.

### CLAIM OF PRIORITY

This application claims the benefit of U.S. Provisional Patent Application No. 62/141,129, entitled “DYNAMICALLY CREATED CONTEXTUAL INFORMATION AS A BROWSER EXTENSION,” by Kedao Wang, et al., filed Mar. 31, 2015, the entire contents of which is incorporated herein by reference.

### TECHNICAL FIELD

Embodiments relate to browser extensions. More particularly, embodiments relate to techniques for providing dynamically generated sidebar information from multiple sources as a browser extension.

### BACKGROUND

Electronic device users have access to vast amounts of information. Unfortunately, this information is typically not available though a single interface, which requires the user to switch between applications or data sources. This can lead to inefficiencies, data errors and/or user frustration.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is an illustration of one embodiment of a browser accessing email functionality with a sidebar to provide information related to one or more recipients of an email message.

FIG. 2 is an illustration of one embodiment of a sidebar that provides customer relationship management (CRM) information.

FIG. 3 is an illustration of one embodiment of a sidebar that supports creation of a follow-up task in a CRM environment.

FIG. 4 is an illustration of one embodiment of a sidebar that supports adding of relationships within a CRM environment.

FIG. 5 is an illustration of one embodiment of a sidebar that supports changing of a status within a CRM environment.

FIG. 6 is an illustration of one embodiment of a sidebar that supports creating a global follow-up within a CRM environment.

FIG. 7 is a block diagram of one embodiment of an electronic system.

FIG. 8 is an illustration of one embodiment of a technique for saving contact information in a CRM database.

FIG. 9 is an illustration of one embodiment of an interface for editing contact information.

FIG. 10 illustrates one embodiment of a sidebar with the profile tab selected.

### DETAILED DESCRIPTION

In the following description, numerous specific details are set forth. However, embodiments of the invention may be practiced without these specific details. In other instances, well-known circuits, structures and techniques have not been shown in detail in order not to obscure the understanding of this description.

Described herein are architectures and mechanisms to provide contextually relevant information in a sidebar that can be presented, for example, as a browser sidebar. Other configurations can also be supported, for example, a floating top or bottom bar, a drop-down menu, a display on a wearable device (e.g., watch, glasses). In one embodiment, information can be gathered from multiple sources, for example, one or more social networks, an internal database (e.g., customer relationship management, CRM), and/or a third-party information service, etc.

The information can be provided to a user in one or more interfaces, for example, when using a browser to access electronic mail, when accessing a social media network, when accessing a CRM. In the description that follows, contextually relevant information is provided as a sidebar when a user utilizes electronic mail using a browser. However, this is only one example of the many possible embodiments.

In one embodiment, when a user is reading an email, a sidebar displays information about a first recipient in message. Information can also be provided about a most recently added or most recently selected recipient. In one embodiment, when the user is composing an email, sidebar can display information about last recipient in To/CC line.

In one embodiment, the sidebar information related to a recipient can be retrieved from a CRM database and can be, for example, list to which the current contact belongs. Relationships corresponding to the current contact and/or various field values for the recipient and/or relationship. In one embodiment, profile information related a recipient. For example, the recipient's title, company name, company description, etc. Also, social profile information (e.g., from Facebook, LinkedIn) can be provided. In one embodiment, analysis can be performed to determine which team member knows (or has the most contact with) the recipient. In one embodiment, users can select which CRM, out of multiple CRMs, to read/write the contextual data.

While most of the examples provided are in terms of electronic mail interfaces and messages, the dynamic contextual information can be provided in many other environments. The following is just a few of the possible alternatives. Any website with information related to a person or individual entity, such as Facebook®, Twitter®, LinkedIn®. The dynamic contextual information (whether presented as a sidebar or in another format) can display information about a person, when the webpage is on, for example, a profile page in Facebook/Twitter/LinkedIn, or when mouse is hovering on a link to a contact's profile page.

As another example, dynamic contextual information can be provided in association with any website with company information. For example, from the domain of current URL, information about the company (e.g., in a sidebar or bottom bar). Information can also be provided when user hovers/selects-text on a company name. Other implementations can also be provided.

In one embodiment, follow-up information can be provided. For example, any follow-ups for the user related to the recipient(s). In one embodiment, global follow-up information can be provided, for example, all follow-ups related to an organization or group, etc.

In one embodiment, in order to avoid extension conflicts, the system attempts to detect if two extensions use the same method interface with different implementations, after a certain period of time has passed to ensure the other extension has fully loaded. If there is a conflict, the reference(s) to the overridden function (used by the other extension) can be saved, the interface is re-overridden by a top-level function, which multiplexes the call to the correct implementation, based on the caller deduced from a stack trace at run-time of the call.

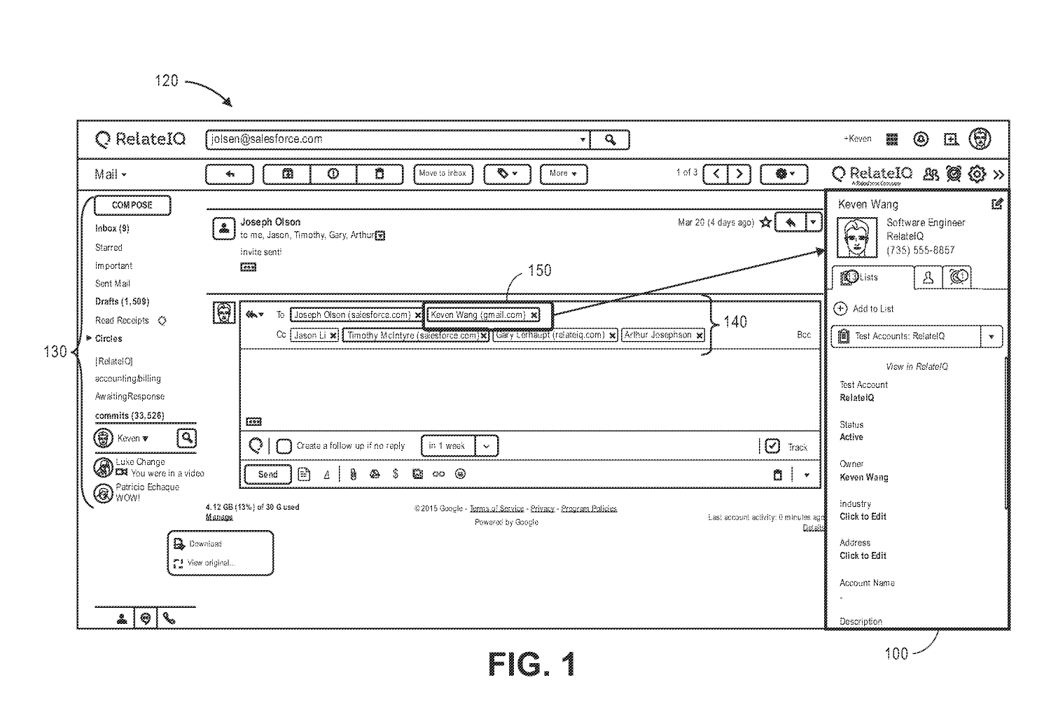

FIG. 1 is an illustration of one embodiment of a browser accessing email functionality with a sidebar to provide information related to one or more recipients of an email message. In one embodiment, the dynamically presented contextual information is presented as sidebar 100 (illustrated on the right side of a graphical user interface). However, presentation of this information is not limited to a sidebar (or even a bar-type window/graphic). Various features and elements of sidebar 100 are described in greater detail below.

In one embodiment, sidebar 100 is provided by a browser (e.g., Internet Explorer®, Chrome®, Safari®, Firefox®) extension. Generally speaking, a browser extension is a computer program that extends the functionality of a browser in some way. Depending on the browser and the version, the term may be distinct from similar terms such as plug-in or add-on. Some extensions are authored using web technologies such as HTML, JavaScript, and CSS. Browser extensions can change the user interface of the web browser without directly affecting viewable content of a web page, for example, by adding sidebar 100.

In one embodiment, sidebar 100 is provided when a user utilizes browser 120 to access an email application/site (e.g., Gmail, Yahoo! Mail, Hotmail, iCloud). In the example of FIG. 1, navigation panel 130 allows the user to create/compose, edit, send, save, delete, organize various email messages in the normal manner provided by the email application/site. In one embodiment, when a user provides a recipient (e.g., 150), sidebar 100 provides information corresponding to that recipient. Multiple recipients (140) can be included in an email message.

In one embodiment, sidebar provides information relating to recipient 150 from internal data sources (e.g., CRM database, HR profile) and/or from external data sources (e.g., social media sites, professional networks, news sites, third-party information gathering services).

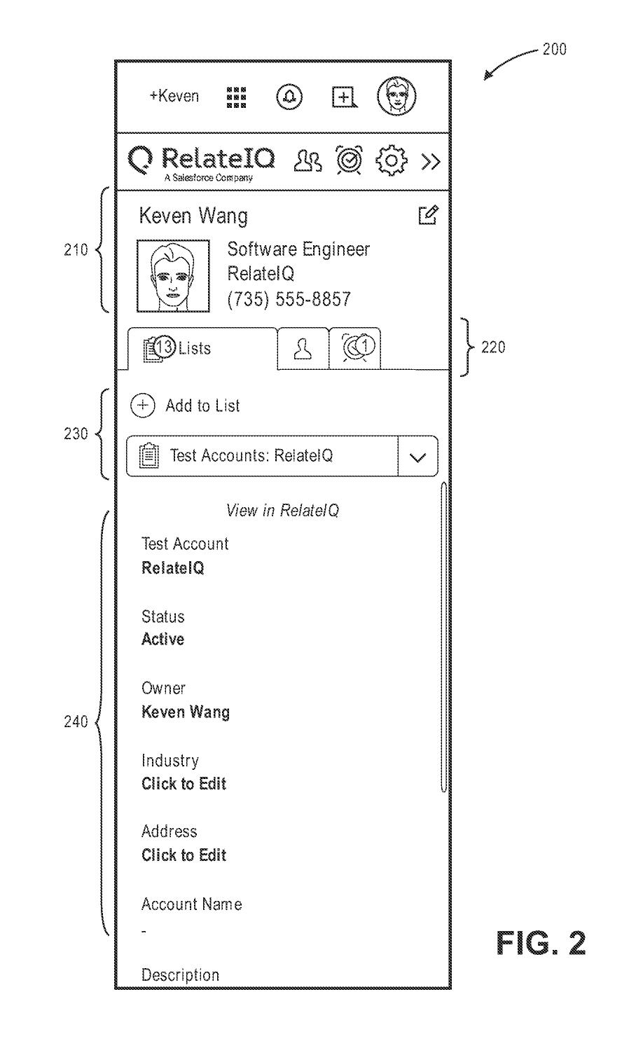

FIG. 2 is an illustration of one embodiment of a sidebar that provides customer relationship management (CRM) information. The example of FIG. 2 illustrates an example sidebar without the context of a browser window; however, the sidebar can be provided in the context described above with respect to FIG. 1. The fields and functionality described with respect to FIG. 2 are examples and other and/or different information can also be provided.

In one embodiment, sidebar 200 provides a contact overview section 210, which can include, for example, a picture, contact information, etc. In one embodiment, sidebar 200 also provides one or more tabs 220 or other navigational elements (e.g., lists, alerts, contact info) that can allow a user to navigate to different types of information related to the contact.

In one embodiment, sidebar 200 can provide access to one or more lists to which the contact belongs via list navigation section 230. Lists can include various organizations and/or groups (e.g., clients, positions, schedule) to which the contact belongs. In one embodiment, detail section 240 can provide more detailed information related to the contact. For example, accounts, status, industry, address, description, notes, calendar information, etc.

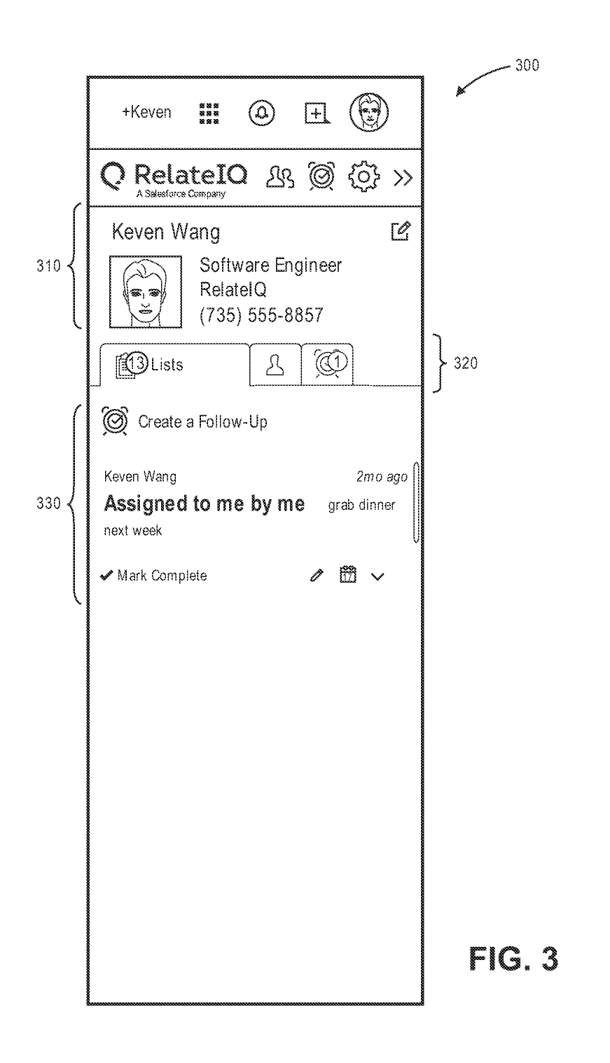

FIG. 3 is an illustration of one embodiment of a sidebar that supports creation of a follow-up task in a CRM environment. The example of FIG. 3 illustrates an example sidebar without the context of a browser window; however, the sidebar can be provided in the context described above with respect to FIG. 1. The fields and functionality described with respect to FIG. 3 are examples and other and/or different information can also be provided.

In one embodiment, sidebar 300 provides a contact overview section 310, which can include, for example, a picture, contact information, etc. In one embodiment, sidebar 300 also provides one or more tabs 320 or other navigational elements (e.g., lists, alerts, contact info, follow up) that can allow a user to navigate to different types of information related to the contact. In the example of FIG. 3, the follow-ups tab is selected.

In one embodiment, in response to selecting the follow-up tab within tabs 320, follow-up section 330 may be provided to allow a user to create a follow-up task that can be assigned, for example, within an email application/site or within another application (e.g., a CRM application).

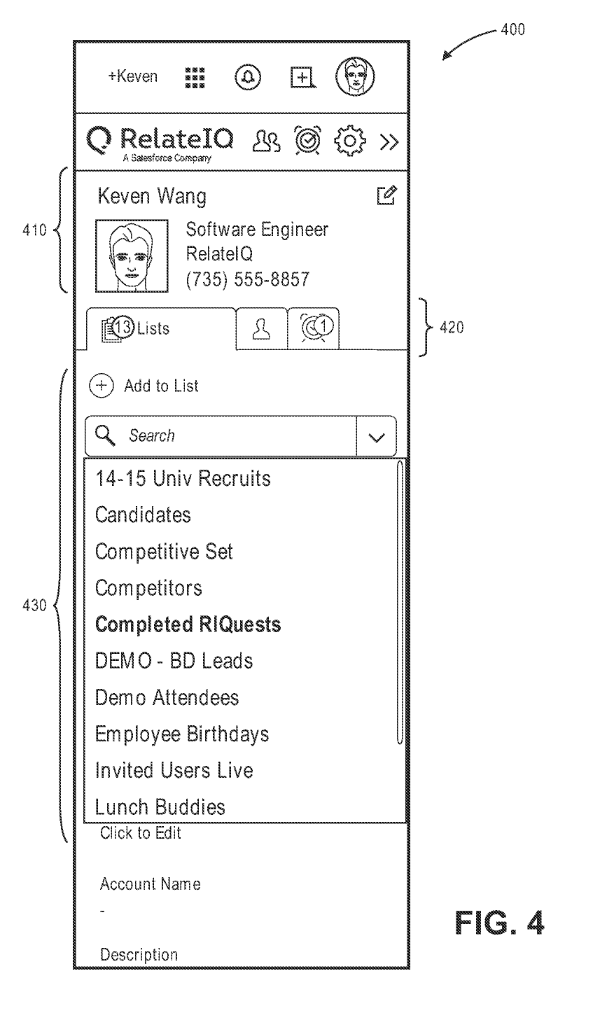

FIG. 4 is an illustration of one embodiment of a sidebar that supports adding of relationships within a CRM environment. The example of FIG. 4 illustrates an example sidebar without the context of a browser window; however, the sidebar can be provided in the context described above with respect to FIG. 1. The fields and functionality described with respect to FIG. 4 are examples and other and/or different information can also be provided.

In one embodiment, sidebar 400 provides a contact overview section 410, which can include, for example, a picture, contact information, etc. In one embodiment, sidebar 400 also provides one or more tabs 420 or other navigational elements (e.g., lists, alerts, contact info, follow up) that can allow a user to navigate to different types of information related to the contact. In the example of FIG. 4, the list tab is selected.

In one embodiment, in response to selecting the list tab within tabs 420, list section 430 may be provided to allow a user to create and/or modify lists to which the contact belongs. List section 430 can also allow a user to modify and/or add relationships describing the contact.

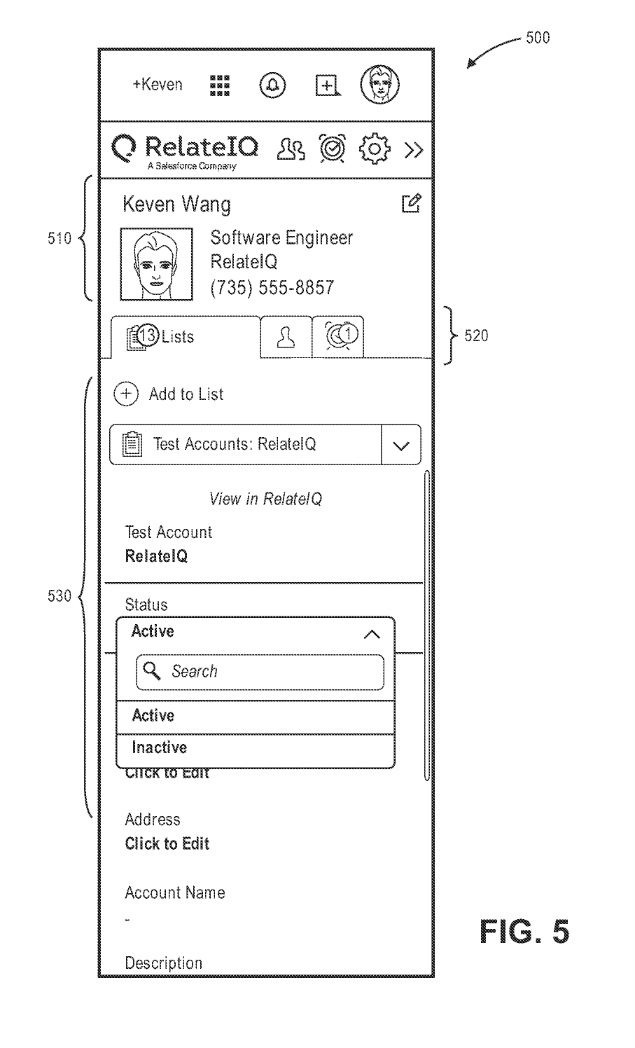

FIG. 5 is an illustration of one embodiment of a sidebar that supports changing of a status within a CRM environment. The example of FIG. 5 illustrates an example sidebar without the context of a browser window; however, the sidebar can be provided in the context described above with respect to FIG. 1. The fields and functionality described with respect to FIG. 5 are examples and other and/or different information can also be provided.

In one embodiment, sidebar 500 provides a contact overview section 510, which can include, for example, a picture, contact information, etc. In one embodiment, sidebar 500 also provides one or more tabs 520 or other navigational elements (e.g., lists, alerts, contact info, follow up) that can allow a user to navigate to different types of information related to the contact. In the example of FIG. 5, the list tab is selected.

In one embodiment, in response to selecting the list tab within tabs 520, list section 530 may be provided to allow a user to create and/or modify a status for the contact.

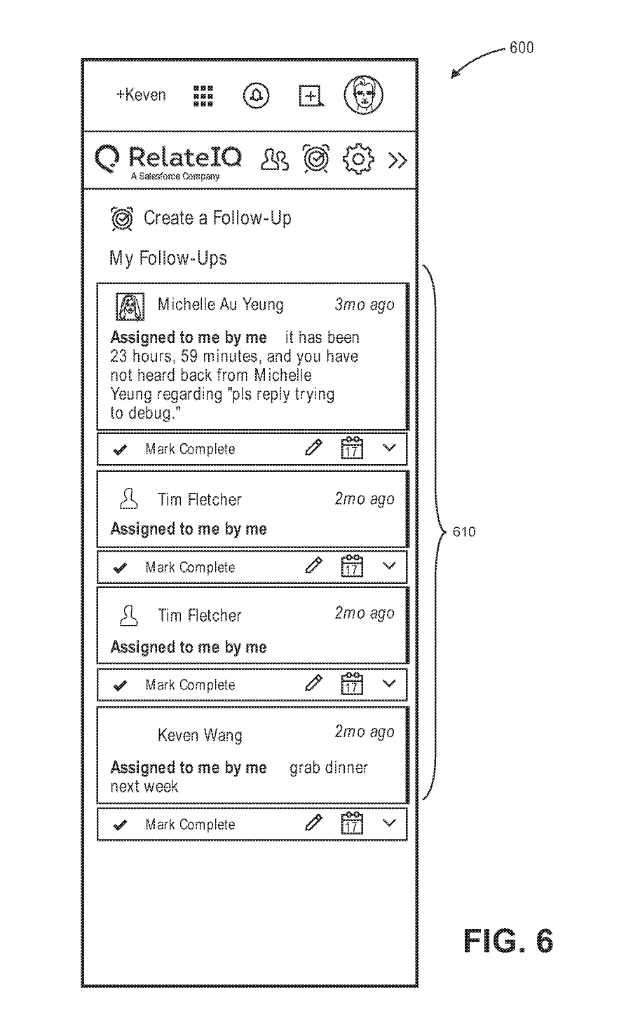

FIG. 6 is an illustration of one embodiment of a sidebar that supports creating a global follow-up within a CRM environment. The example of FIG. 6 illustrates an example sidebar without the context of a browser window; however, the sidebar can be provided in the context described above with respect to FIG. 1. The fields and functionality described with respect to FIG. 6 are examples and other and/or different information can also be provided.

In one embodiment, sidebar 600 provides the ability to create a global follow-up for multiple people within an organization. In one embodiment, follow-up section 610 allows the user to provide information to generate a follow-up task.

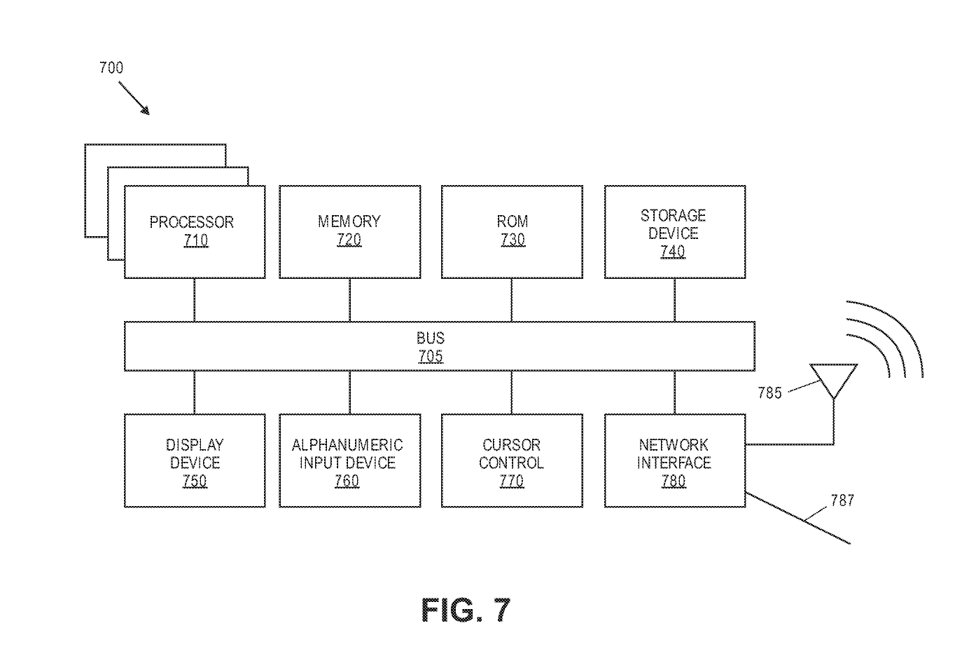

FIG. 7 is a block diagram of one embodiment of an electronic system. The electronic system illustrated in FIG. 7 is intended to represent a range of electronic systems (either wired or wireless) including, for example, desktop computer systems, laptop computer systems, cellular telephones, personal digital assistants (PDAs) including cellular-enabled PDAs, set top boxes, tablets, etc. Alternative electronic systems may include more, fewer and/or different components.

Electronic system 700 includes bus 705 or other communication device to communicate information, and processor 710 coupled to bus 705 that may process information. While electronic system 700 is illustrated with a single processor, electronic system 700 may include multiple processors and/or co-processors. Electronic system 700 further may include random access memory (RAM) or other dynamic storage device 720 (referred to as main memory), coupled to bus 705 and may store information and instructions that may be executed by processor 710. Main memory 720 may also be used to store temporary variables or other intermediate information during execution of instructions by processor 710.

Electronic system 700 may also include read only memory (ROM) and/or other static storage device 730 coupled to bus 705 that may store static information and instructions for processor 710. Data storage device 740 may be coupled to bus 705 to store information and instructions. Data storage device 740 such as a magnetic disk or optical disc and corresponding drive may be coupled to electronic system 700.

Electronic system 700 may also be coupled via bus 705 to display device 750, such as a cathode ray tube (CRT) or liquid crystal display (LCD), to display information to a user. Alphanumeric input device 760, including alphanumeric and other keys, may be coupled to bus 705 to communicate information and command selections to processor 710. Another type of user input device is cursor control 770, such as a mouse, a trackball, or cursor direction keys to communicate direction information and command selections to processor 710 and to control cursor movement on display 750.

Electronic system 700 further may include network interface(s) 780 to provide access to a network, such as a local area network. Network interface(s) 780 may include, for example, a wireless network interface having antenna 785, which may represent one or more antenna(e). Network interface(s) 780 may also include, for example, a wired network interface to communicate with remote devices via network cable 787, which may be, for example, an Ethernet cable, a coaxial cable, a fiber optic cable, a serial cable, or a parallel cable.

In one embodiment, network interface(s) 780 may provide access to a local area network, for example, by conforming to IEEE 802.11b and/or IEEE 802.11g standards, and/or the wireless network interface may provide access to a personal area network, for example, by conforming to Bluetooth standards. Other wireless network interfaces and/or protocols can also be supported.

IEEE 802.11b corresponds to IEEE Std. 802.11b-1999 entitled “Local and Metropolitan Area Networks, Part 71: Wireless LAN Medium Access Control (MAC) and Physical Layer (PHY) Specifications: Higher-Speed Physical Layer Extension in the 2.4 GHz Band,” approved September 76, 7999 as well as related documents. IEEE 802.11g corresponds to IEEE Std. 802.11g-2003 entitled “Local and Metropolitan Area Networks, Part 71: Wireless LAN Medium Access Control (MAC) and Physical Layer (PHY) Specifications, Amendment 4: Further Higher Rate Extension in the 2.4 GHz Band,” approved Jun. 27, 2003 as well as related documents. Bluetooth protocols are described in “Specification of the Bluetooth System: Core, Version 7.1,” published Feb. 22, 2001 by the Bluetooth Special Interest Group, Inc. Associated as well as previous or subsequent versions of the Bluetooth standard may also be supported.

In addition to, or instead of, communication via wireless LAN standards, network interface(s) 780 may provide wireless communications using, for example, Time Division, Multiple Access (TDMA) protocols, Global System for Mobile Communications (GSM) protocols, Code Division, Multiple Access (CDMA) protocols, and/or any other type of wireless communications protocol.

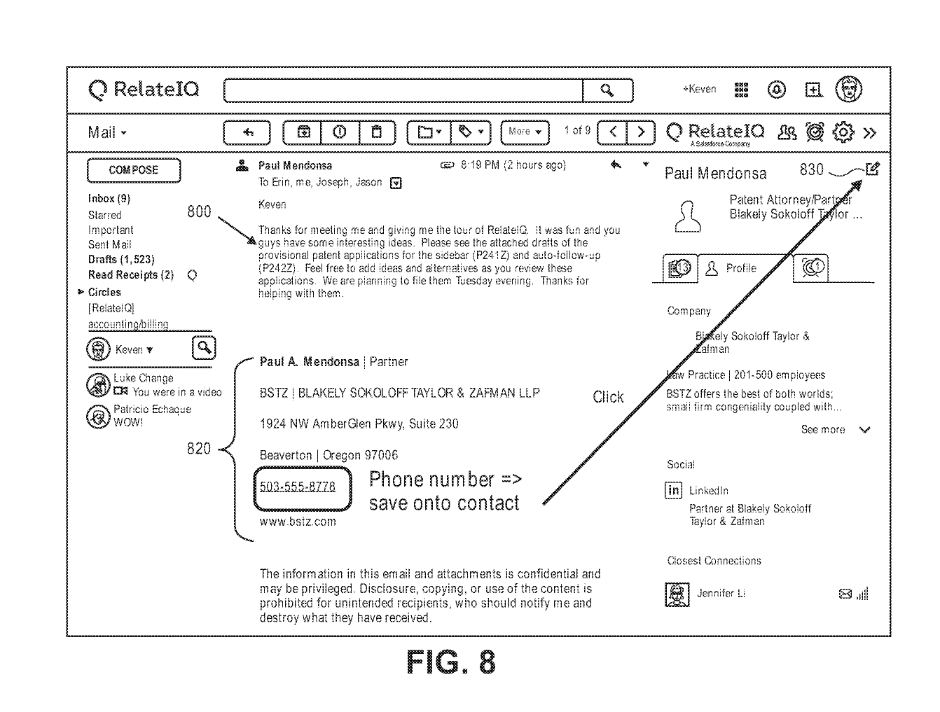

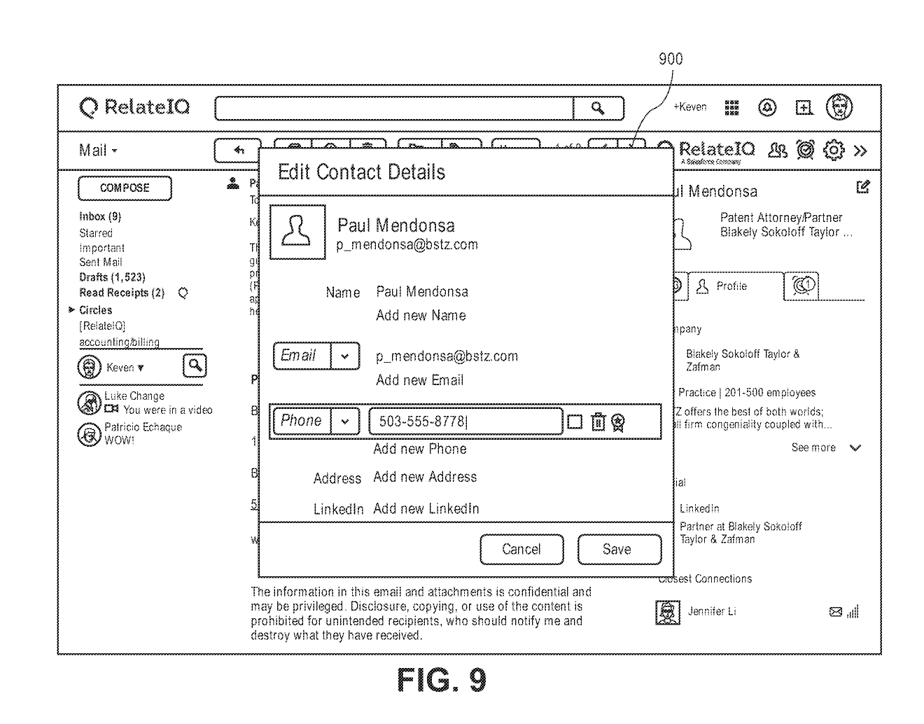

FIG. 8 is an illustration of one embodiment of a technique for saving contact information in a CRM database. In one embodiment, the browser extension allows user to save data into CRM database. For example, when a user is in the context of an email (e.g., email message 800), a sales person sees an email signature (820) with a client's title, phone number, and address. The user can save this data onto the contact (see Edit Contact Details 900 in FIG. 9) in CRM right from the browser extension by, for example, clicking on edit icon 830. As another example (not illustrated in FIG. 8), a user can change the deal status to “deal won” when a client has replied an email with a signed contract.

In one embodiment, the browser extension bundled code can be hosted on a provider's server (e.g., a CRM provider server, instead of by a browser provider, for example, web store's package). Typically the browser web store package lives inside a user's local machine. In one embodiment, the web store package is a light weight loader script (e.g., ˜100's of lines), which fetches and executes a bundled script (e.g., ˜100,000s of lines) that contains, for example, the business logic and user interface (UI) of the browser extension. By hosting a significant portion of the application on the provider's server, rapid deployment can be supported. This minimizes the dependency on the web store's deployment schedule, and maximizes freedom to rapidly deploy. When the provider wants to push new features or fix bugs, they just update the bundled script on the server.

In one embodiment, in order to enable rapid deployment, the browser extension code can be pushed to production frequently (e.g., every night, once a week, twice a week). In one embodiment, the browser extension code gets deployed frequently (e.g., every night) as part of a production push. Thus, every time a user opens/refreshes a page where dynamically provided contextual information is provided, the user will get latest build of the extension. In one embodiment, this is provided with a lightweight loader script that ships with browser extension web-store package. In one embodiment, that script's only responsibility is to load the latest code from host server, and run it inside current webpage securely.

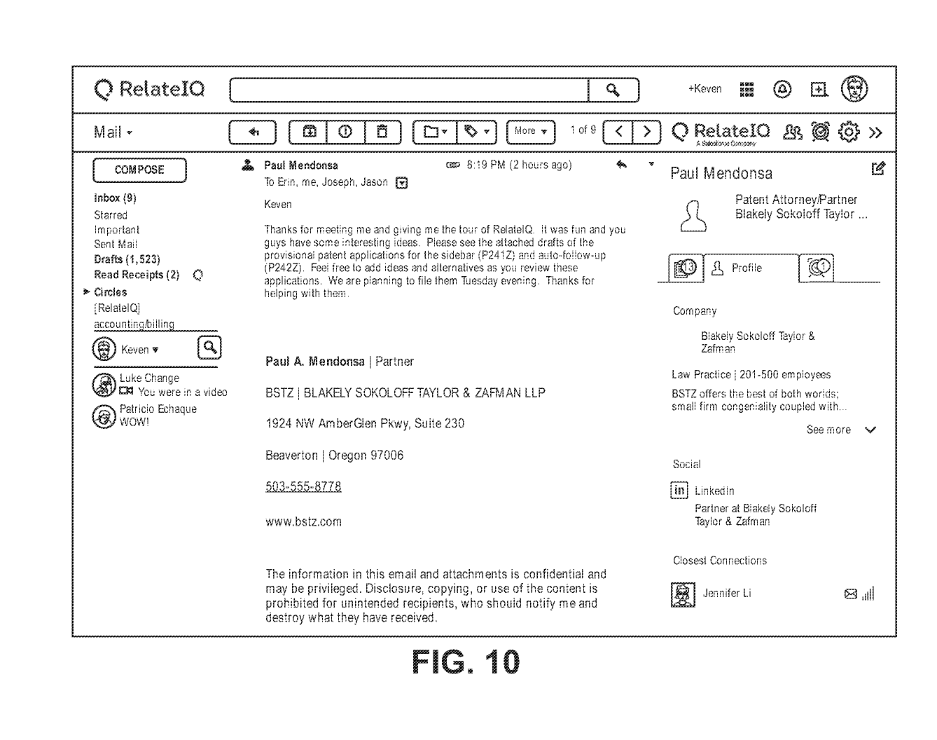

FIG. 10 illustrates one embodiment of a sidebar with the profile tab selected. In one embodiment, the “Profile” tab shows a) company meta data, by inducing from email domain, or by looking up from CRM/third party database; b) contact social profile links c) closest connections—which teammates know this contact the best? This is but one example of the type of information that can be provided via the profile tab.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A hardware electronic computing device operating to provide a communications application, the computing device and communications application to:
provide access to a user interface (UI) of the communications application via the hardware computing device;
automatically provide contextual information corresponding to individual entities corresponding to recipients of messages to be transmitted by the communications application, wherein the contextual information is retrieved from at least one internal source and at least one external source;
dynamically update the contextual information in response to input provided to the communications application through the UI.

2. The hardware electronic computing device of claim 1 wherein the communications application comprises an electronic mail application.

3. The hardware electronic computing device of claim 1 wherein the communications application comprises a browser application.

4. The hardware electronic computing device of claim 1 wherein the communications application comprises a social media application.

5. The hardware electronic computing device of claim 1 wherein the communications application comprises an instant messaging application.

6. The hardware electronic computing device of claim 1 wherein the individual entitles comprise one or more electronic mail recipients.

7. The hardware electronic computing device of claim 1 wherein the individual entitles comprise one or more entities tagged in a social media post.

8. The hardware electronic computing device of claim 3 wherein the contextual information is provided via a browser plug-in.

9. The hardware electronic computing device of claim 1 wherein the internal source comprises a customer relationship management (CRM) database.

10. The hardware electronic computing device of claim 1 wherein the external source comprise at least one social network.

11. A non-transitory computer readable medium having stored thereon instructions that, when executed by one or more processors, cause the one or more processors to:
provide access to a user interface (UI) of a communications application via a hardware computing device;
automatically provide contextual information corresponding to individual entities corresponding to recipients of messages to be transmitted by the communications application, wherein the contextual information is retrieved from at least one internal source and at least one external source;
dynamically update the contextual information in response to input provided to the communications application through the UI.

12. The non-transitory computer readable medium of claim 11 wherein the communications application comprises an electronic mail application.

13. The non-transitory computer readable medium of claim 11 wherein the communications application comprises a browser application.

14. The non-transitory computer readable medium of claim 11 wherein the communications application comprises a social media application.

15. The non-transitory computer readable medium of claim 11 wherein the communications application comprises an instant messaging application.

16. The non-transitory computer readable medium of claim 11 wherein the individual entitles comprise one or more electronic mail recipients.

17. The non-transitory computer readable medium of claim 11 wherein the individual entitles comprise one or more entities tagged in a social media post.

18. The non-transitory computer readable medium of claim 13 wherein the contextual information is provided via a browser plug-in.

19. The non-transitory computer readable medium of claim 11 wherein the internal source comprises a customer relationship management (CRM) database.

20. The non-transitory computer readable medium of claim 11 wherein the external source comprise at least one social network.

21. A method of providing a communications application, the method comprising:
providing access to a user interface (UI) of the communications application via the hardware computing device;
automatically providing contextual information corresponding to individual entities corresponding to recipients of messages to be transmitted by the communications application, wherein the contextual information is retrieved from at least one internal source and at least one external source;
dynamically updating the contextual information in response to input provided to the communications application through the UI.

22. The method of claim 21 wherein the communications application comprises an electronic mail application.

23. The method of claim 21 wherein the communications application comprises a browser application.

24. The method of claim 21 wherein the communications application comprises a social media application.

25. The method of claim 21 wherein the communications application comprises an instant messaging application.

26. The method of claim 21 wherein the individual entitles comprise one or more electronic mail recipients.

27. The method of claim 21 wherein the individual entitles comprise one or more entities tagged in a social media post.

28. The method of claim 23 wherein the contextual information is provided via a browser plug-in.

29. The method of claim 21 wherein the internal source comprises a customer relationship management (CRM) database.

30. The method of claim 21 wherein the external source comprise at least one social network.
